(19) United States
(12) Patent Application Publication
(10) Pub. No.: US 2006/0041836 A1
(43) Pub. Date: Feb. 23, 2006

(54) Information documenting system with improved speed, completeness, retriveability and granularity

(76) Inventors: T. John Gordon, Forestville, CA (US); Dennis Hawley, Tiburon, CA (US)

Correspondence Address: Dennis Hawley, P. O. Box 1232, Tiburon, CA, 94926, US

(21) Appl. No.: 10/660,854

(22) Filed: Sep. 12, 2003

Related U.S. Application Data
(60) Provisional application No. 60/410,856, filed on Sep. 12, 2002.

(51) Int. Cl. G06F 17/00

(52) U.S. Cl. 715/513

(57) ABSTRACT

An information documenting system that makes use of structured documents and a knowledge tree with links to information and/or to other structured documents such that information from the knowledge tree can be inserted in the structured document as the discretion of the user. Further an information documenting system that makes use of tags in a structured document such that information may be imported from databases or other documents and exported to databases and other structured documents; and makes use of tags such that documents can be formatted to the user's specification(s) and information can be selected for inclusion in or exclusion from a final document.

We claim the benefit of PPA 60/410,856.

### SEQUENCE LISTING OR PROGRAM

A computer program is included on CD ROM as an Appendix.

### BACKGROUND

1. Field of the Invention

This application relates to documentation software and systems and particularly to automated production of professional documents.

2. Prior Art

Creating, handling, and reviewing documentation, or paperwork, has long been an important part of the workday for people employed in many different occupations. Unfortunately, it is often done incompletely or not at all, leaving individuals and organizations without a sufficiently complete record of their activities. Without sufficiently complete records, future decisions that should be based upon past documentations or findings can be faulty and/or hard to defend. Without proper documentation, it may be difficult or impossible to prove that certain activities took place.

For example, good medical practice indicates that a physician, when examining a patient for possible infection, review the patient's history of allergies to medication. Failure to document such a review, even if the review took place and the physician has a memory of the review, can expose individuals and organizations to legal liability. Failure to conduct such a review can also lead to errors in patient management. Failure to find the information that documents the result of such a review also can lead to errors in patient management.

Furthermore, the price of many services is often dependent upon and supported by documentation about the nature and scope of those services and the findings that were made as the result of those services. Lack of complete documentation can make it difficult for an individual or an entity to support all of the charges for services. Lack of complete documentation can mean that an individual or an entity actually receives less money for services than they would have received with complete documentation of those services.

Typically, when a professional makes an observation (e.g. a physician examines a patient or a law enforcement officer sees potentially illegal activity) they document this observation. Often, there are many variables that an observer must review and include in the documentation. Generally there are more variables than the observer has the time or resources to document.

Or the professional can take an action (e.g. performing a medical procedure or arresting a suspect) and must document their action(s) and the result of the action(s). Again there are a large number of variables and limited resources of time to document all relevant events and/or observations.

Incomplete documentation can create problems. In the world of medicine, insurance, and the law, it has become axiomatic that “if the doctor didn't document it, the doctor didn't do it.” This is particularly burdensome for physicians because they typically do many things in talking to and examining a patient that they do not have time to document. Documentation in general, and medical documentation in particular, concentrates on positive findings, e.g., a high temperature that may indicate an infection. Yet negative (normal) findings are important and should be documented for professional reasons and/or legal reasons.

For example, a primary-care physician, when examining a patient for a low back strain, would be aware of whether the patient's judgment and insight were within the appropriate and normal range and whether the patient had an appropriate orientation to time, place, and person. Nonetheless, this brief psychological exam is almost never documented unless there is a positive (abnormal) finding. In many cases we suspect that the physician does not focus on the fact that there is a negative finding. Yet it is pertinent information that should be recorded.

The Health Care Financing Administration (HCFA) of the United States Department of Health and Human Services has set forth a series of recommended physical examinations. In addition to a general multi-system exam, HCVA has set forth the following Single System exams: Cardiovascular, ENT & Mouth, Eyes, Genito-urinary, male, Genito-urinary, female, Hema/lymph/Immun, Musculoskeletal, Neurological, Psychiatric, Respiratory, and Skin.

Certain information should be documented for each exam whether the finding is positive (abnormal) or negative (normal). Moreover, each exam sets forth certain “bullet points” (specific, important information). The number of bullet points included in a document is one element in determining the fees that HCFA will allow the physician to charge for Medicare patients. The number of body systems examined (e.g. cardiovascular, respiratory, musculoskeletal) is another element. Many insurance companies rely on HCFA billing standards to determine allowable charges for non-Medicare patients. Thus the thoroughness of a physician's documentation can be directly related to the level of the physician's income.

Returning to our example, the Single System Musculoskeletal System exam recommends a psychiatric review, and gives “bullet points” toward higher billing levels for documenting the psychiatric review. Thus there is a financial incentive for physicians to document their work completely. However, because of time constraints and the fact that physicians focus on the positive (abnormal) findings, it is unrealistic to expect that they will fully document their negative findings, even though it is to their financial advantage to do so.

Besides completeness and speed of documentation, there is a need to reproduce all or selected parts of a document at will. In most documentation systems, the same information is entered multiple times to meet differing purposes or functions. For example, the physician records in a patient's chart any new medication that has been prescribed. The same information must be recorded in a prescription that is delivered to the pharmacy, and then the same information may be entered again when an insurance company or another physician needs it. Presently, most physician offices enter this information each time it is needed. This causes unnecessary work and increases the possibility of error.

Furthermore, when a physician sees a patient on follow-up, information is needed about prior examinations in an easy-to-find and easy-to-use format. For a physician, an accurate summary of past visits is very useful and often beneficial to the patient. Thus, the ability of a documentation system to collect and retrieve information and organize it in a structured format is highly valuable.

There is a particular documentation structure that many physicians are taught in medical school as a preferred format for clinical documentation. This structure is called a SOAP note. SOAP is an acronym that stands for Subjective (what a patient says about the ailment); Objective (what a physician observes about the patient's condition); Assessment (what a physician assesses the problem to be); and Plan (what the physician decides to do about the ailment).

Sometimes these sections are called by other names; for example Assessment is sometimes called Impressions. Nonetheless, the SOAP note is ubiquitous in medicine.

The SOAP sections of a medical note can be further divided and subdivided. For example, within the Subjective section there can be a Chief Complaint; a History of Present Illness; one or more Review of Systems; a Past Medical History; a Social History; and a Family History. (The last three are sometimes referred to as the PMFSHx.) Each of these sections can be subdivided. For example, the History of Present Illness can be subdivided into the HCFA suggested categories of Location, Quality, Severity, Duration, Timing, Context, Modifying Factors, and Associated Signs and Symptoms. If needed, each of these categories can be further subdivided and so on.

In addition, it is valuable if information can be retrieved (extracted) in discreet data elements; discreet data elements are sometimes call grains of information, and a document in which grains of information are available electronically is sometimes referred to as having “granularity. Granularity is the extent to which information in a system is divided into separate components (like granules). The more information components a system has—the greater the granularity. The greater the granularity in a documenting system—the more powerful the system is. If the user is able to select the information that is to be available in granular form, the system is also flexible.

For example, the user can determine that information about blood pressure can be expressed in such a manner that the systolic and diastolic values are not separable, e.g., 110/70. Or the user can determine that the systolic value “110” could be retrieved separately from the diastolic value “70.” This might be useful, for example, if the user were interested in all patients with abnormal systolic values no matter what the diastolic value.

The current methods that medical doctors use to document their clinical activities can be divided into the following categories: (1) dictation/transcription; (2) handwriting; (3) dictation into a computer-based speech engine; (4) typing into a word processor; (5) using computer based “point and click” systems; and (6) using systems that purport to add artificial intelligence to the diagnostic process.

Dictation/transcription into a voice recorder predominates in the sub-specialties of medicine, e.g., cardiology, gastroenterology. It is also dominant in the surgical subspecialties, e.g., urology and orthopedics. Depending upon the skill of the person doing the documenting, it can produce accurate and legible documents, but it is seldom as complete as pre-designed, structured templates. Moreover it is time-consuming and expensive. Transcription charges can be in the range of eight to sixteen cents per line.

Much of the language that is dictated is dictated over and over again. In fact many physicians, in an effort to save time, speak at such a rapid rate that the normal layperson will not understand. In order to transcribe this dictation, the transcriptionist either slows down the replay rate of the voice tape or transcribes based on the knowledge gained from having typed the same material many, many times, i.e., sometimes the transcriptionist remembers as well as listens. Thus, dictation/transcription is a laborious, expensive, time-consuming process, and still errors and incompleteness persist in transcribed copy.

In general, transcribed documents lack sufficient organization and granularity. The lack of organization is manifest when one looks for a particular piece of information. The reader may have to wade through much information in which there is no interest before finding the information that is of interest. Further, and even more problematic, information in transcribed documents is not “granular.” Lack of granularity means that particular and highly critical information, such as diagnosis, treatment plan, or medication history, or an observation such as blood pressure cannot easily be found or extracted by hand or electronically.

Sometimes a transcriptionist will construct a document using a macro. Macros are form paragraphs or other pre-written blocks of text that can be inserted into the documentation as instructed by the physician or determined by the transcriptionist. Macros can save time and increase completeness, but they lack flexibility, structure, and granularity. Because of their lack of flexibility it is often difficult to cause a macro to fit a particular documentation need. Furthermore, to adequately cover a particular area of medicine, the number of macros can become so large that management becomes cumbersome and unwieldy, and it becomes difficult for the physician to remember the content of each macro so as to know when to insert a particular macro.

In general, storage and retrieval of completed documentation is done by placing pieces of paper containing patient information into a folder, sometimes called a “chart.” Sometimes the paper is fastened to the folder by means of prong paper fasteners. Other times, it is not fastened into the folder. This system has the obvious disadvantages that paper documents can be lost before or after being filed in the chart; or they can be removed from the chart and not replaced. The chart itself can be lost or misplaced for a period of time. These errors can result in poor patient care that can range from minor inconvenience to the death of the patient.

Even in the case where all of the paper documents are in the chart, the lack of completeness of the documents can lead to errors. Further, even if the relevant information is available in the chart, it may not be readily available to medical personnel, because personnel do not, or cannot, extract the relevant information from the mass of other information.

Handwriting is also a common form of documentation. Handwriting predominates in primary care specialties, such as family medicine and pediatrics. As will be appreciated, handwriting suffers from lack of legibility. (Physicians in particular are known for their illegible handwriting.) In general, handwritten documents also suffer from lack of completeness and organization, and they do not provide electronic granularity. Handwritten charts also suffer from the same deficiencies of storage and retrieval noted above in dictation/transcription. It is commonly accepted that physicians sometimes lose malpractice lawsuits because of poor quality of handwritten notes.

Paper forms (paper templates) are sometimes used to assist handwritten documentation. Generally, forms are completed by filling in blanks or checking boxes. Forms have the advantage of giving a certain amount of structure to the document. However, they have the disadvantage of lack of flexibility, and they can lead to incomplete documentation.

Typing into a word processor has all the limitations of a transcribed document, with the additional disadvantage that it uses high-cost physician time to create the document.

Dictation into a computer-based speech engine has all the limitations of dictation/transcription and typing into a word processor, with the additional disadvantage that speech engine accuracy depends upon many things, including the skill of the speaker in maintaining a consistently high level of accurate diction throughout the dictation of a long document. Typically, documents created by a speech engine are less accurate that those created by a transcriptionist and it often takes longer for the speaker to create them than it takes to speak the same information into a tape recorder.

There are speech-engine driven documentation systems on the market that contain a database that allows the user to store and retrieve whole documents. In general, they do not have the ability to gather information from other documents in their system or to provide information to other documents in their system nor do they provide for granularity within a document.

Computer based “point-and-click” systems allow the user to select pre-written text from drop-down menus by pointing to it with a mouse and to “click” it into the document using the mouse or a keyboard. Point-and-click systems are slow, restrict the number and content of the pre-written text items, and do not make it easy to add nuances to the documentation. In general, point-and-click systems do not provide the ability to use the same information in different contexts. In general, they do not allow the user to customize the drop-down menus or their content. Thus they lack flexibility.

Systems that purport to add artificial intelligence to the diagnostic process do not in general address the documentation needs that we have discussed. Rather they attempt to help the physician with the diagnostic process. This is most useful in unusual or difficult cases. It is less useful and perhaps a drain on resources in the everyday medicine that constitutes the bulk of patient visits.

With the exception of “point-and-click” systems and systems that purport to add artificial intelligence to the diagnostic process, all of these systems create and rely on a paper record. A physician has this to say about the paper record:
“The (paper) medical record is an abomination . . . it is a disgrace to the profession that created it. More often than not the chart is thick, tattered, disorganized and illegible; progress notes, consultant's notes, radiology reports and nurses notes are all co-mingled in accession sequence. The charts confuse rather than enlighten; they provide a forbidding challenge to anyone who tries to understand what is happening to the patient.”
Bleich, H. MD, Computing Vol. 10 no 2, p 70, 1993
   Objects and Advantages

Accordingly a primary object of the invention is to provide a more efficient and complete system for recording information and for reviewing and using that information in one or more contexts.

Our system provides structure to the documentation process and structure to the documents themselves. Structure allows more efficient production of documents and more efficient review of and extraction of information from completed documents. Structured templates allow a mandated or suggested document structure, e.g., a SOAP note, to be created more easily.

Our system allows links to information (macros and structured documents including structured templates) to be organized on the knowledge tree such that the user can easily find and select desired information and insert that information into the document that is being prepared. The user can review information on the knowledge tree before the information is inserted into the document. Thus the user does not have to remember the name and content of each macro or template.

Our system uses structured templates that may or may not contain content to create a structured document. For example, templates may contain only the structure implied by the SOAP format. Or the template may contain structure and content. Oftentimes the content describes the default or normal conditions. Since, in general, normal conditions obtain more than abnormal conditions, time is saved and completeness and accuracy are enhanced. The structured template, together with the knowledge tree, allows the person documenting to create a relatively complete and relatively accurate structured document in a relatively short period of time.

Our system determines and maintains granularity in the information that is contained in the document. As described above in the example of documenting blood pressure, a user may determine the level of granularity, or a user may determine the information that is to be available in granular form. In any event, both document structure and granularity when used with the knowledge tree are powerful features that give our system multiple advantages over the current state of the art.

Our system may be configured such that documentation may be accomplished in a wide variety of applications and in a wide variety of professions and businesses.

Other objects and advantages of the invention will become apparent from the program listing that is attached and from the following descriptions, taken in connection with the accompanying drawings.

### SUMMARY OF THE INVENTION

Our invention is an information documenting system that uses structured documents (completed documents and templates), a knowledge tree, and a connection between the knowledge tree and the structured document such that information that is linked in the knowledge tree can be inserted into the structured document according to the needs of the user in documenting observations or procedures.

The structured documents within the information documenting system can cause information to be imported from other documents created by the system, and can allow information within a document to be exported to other documents in the system, and can allow additional documents to be created from a prior document. The structured documents within the information documenting system can cause information to be imported from databases and export information from the document to databases.

These capabilities provide improved efficiency in recording information since more information can be recorded in less time. These capabilities provide greater completeness in documenting observations or actions because structured documents can contain default information, and because individuals doing the documenting are often time-limited and sometimes stop documenting when out of time. When already-documented information is required in another context our system provides for greater accuracy as well as time saving since the required information does not have to be entered another time.

### BRIEF DESCRIPTION OF THE DRAWINGS

FIG. 1 is a view of a computer screen showing a basic home screen of a documentation system in accordance with the invention.

FIG. 2 is a view of a computer screen showing a second basic home screen of our documentation system.

FIG. 3 is a view of a computer screen showing a basic edit screen of the documentation system.

FIG. 4 is a view of a computer screen showing a second basic edit screen of the documentation system.

FIG. 5 is a view of a computer screen showing a basic verify screen of the documentation system in accordance with the invention

FIG. 6 is a view of a computer screen showing a basic generated document in an edit screen of the documentation system.

FIG. 7 is a view of a computer screen showing a basic insert manager screen of the documentation system.

FIG. 8 is a view of a computer screen showing a basic insert editor screen of the documentation system.

FIG. 9 is a view of a computer screen showing a basic document type configuration screen of the documentation system.

### DETAILED DESCRIPTION

A method and apparatus for one embodiment of an information documenting system according to our invention is described below and an exemplary software program listing for an embodiment of our documentation system for use in medicine is attached as a CD ROM Appendix.

### Operation—Preferred Embodiment

Our system allows the user to produce structured documents based on structured templates. It uses a knowledge tree for selecting and inserting information into a structured document. The structured templates and structured documents in the preferred embodiment relate to medicine. Templates give structure to the documentation process and to finished documents. Templates may or may not contain information other than structure. Information in templates can be in the nature of a list with default (normal) information, where the user can modify the default information to describe a non-default (abnormal) finding. Information can be in the form of choices, where the user can select the appropriate choice. Choices may be exclusive (only one choice can be selected) or non-exclusive (multiple choices may be selected). A choice may contain default information, where the user can modify the default information.

Finished documents can be clinical descriptions of physician-patient visits and allied documents, e.g., prescriptions, referral letters, patient information sheets, nursing notes, orders, and order progress notes.

A Document Type defines the characteristics of the document. A Document Type must be selected for each document during the document creation process. Document Type characteristics will define specific characteristics that distinguish one document type from another Document Type. Document Type characteristics include: 1) a name; 2) whether a document can be used as a data source for other documents; 3) formatting characteristics; 4) whether the document needs a recipient; 5) the default printer.

The user may create Document Types and define the characteristic of each created Type. The process by which this is done is described below.

The structured nature of our document allows one document to be generated from another document, and allows user-defined information to be automatically shared between documents.

A structured document may be a structured template or a structured finished document.

Installing the Program

The program consists of a single executable file that contains all of the elements of the system. However, the program makes use of numerous elements that provide the underlying functionality that the program uses. To assure that the program will function correctly, the installation process must be run from a CD-ROM; this process copies the necessary files onto the user's computer.

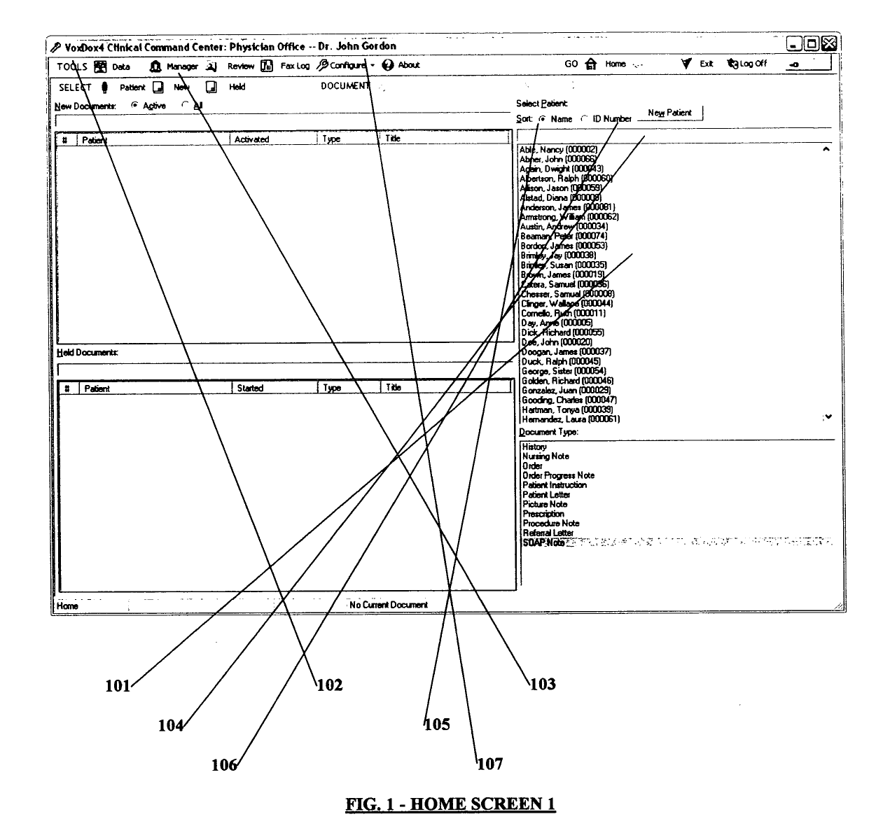

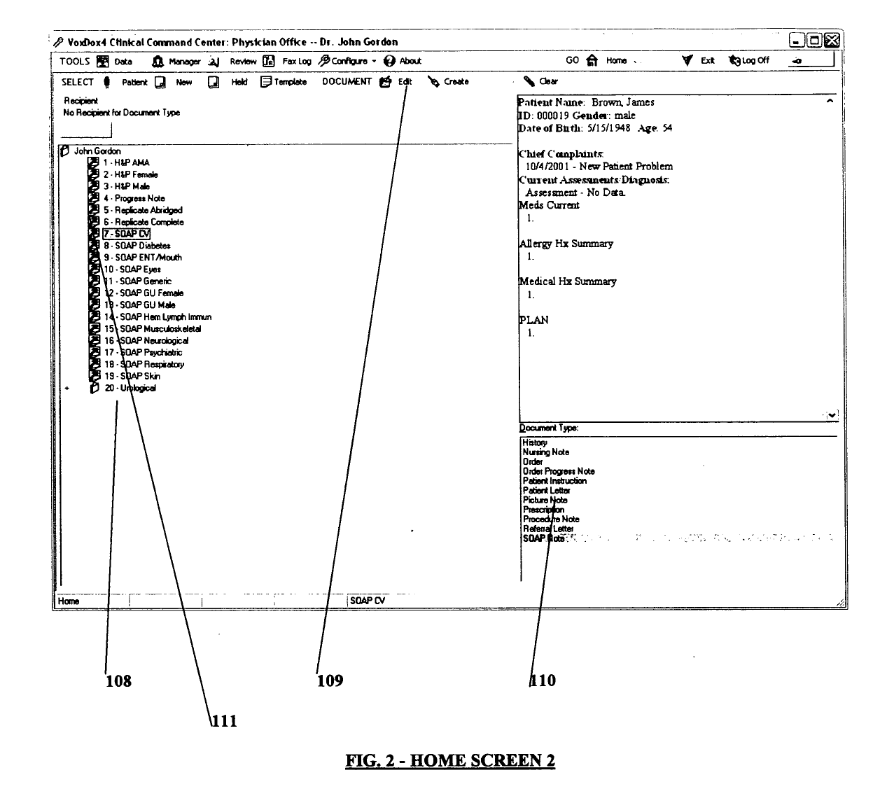

Using the Program—FIGS. 1 and 2

The program uses data sources that are provided with the program.

Optionally, the program can link to other data sources, such as a user-supplied database.

The data sources provided with the program are: 1) database for patient demographics; 2) a database for documents being edited and for documents in their final form; 3) a database for user information; 4) a database for templates and the data that builds the knowledge tree.

These database files are also copied to the user's computer during the installation process. Upon being copied, database files 1, 2, and 3 have no content. The user supplies the content for these databases. Database 4 may contain templates as well as data that builds the knowledge tree. The user may choose to use the data supplied in Database 4, or modify this data, or add customized data, or the user may choose any two of these options, or all three of these options.

After the installation process is completed, including the entry of product codes and keys to license the software program, double-clicking the icon on the user's computer desktop starts the software program. This brings the user to the Home Screen shown in FIG. 1.

To begin the editing process, where the system is actually operated, the user must take the following steps:
1) Select a patient from a patient list 101 by highlighting a patient's name with a mouse, by speaking the patient's name into the integrated speech engine, by typing the patient's last name into a Select Patient window 104 where “Name” is selected as the sorting algorithm by clicking the radio button, “Name” beside Sort 105, or by typing the patient's ID number where ID Number is selected as the sorting algorithm by clicking the radio button, “ID Number” beside Sort 106. After a patient is selected, the Home Screen changes to a Second Home Screen as shown in FIG. 2. The Second Home Screen displays a Template Tree 108.
2) Select a document type from a document type list 110.
3) Select a template from a Home page template tree 108 by highlighting a document's name with a mouse, or by speaking the document's name into the integrated speech engine.
4) Click an Edit button 109 or double-click a template icon 111 to activate the selected template.

Note that all these operations can be performed by using either voice commands, mouse clicks, a touch screen, or a combination of any of the above.

It is also possible to perform these commands using keyboard entries, although this feature is not presently provided in the program.

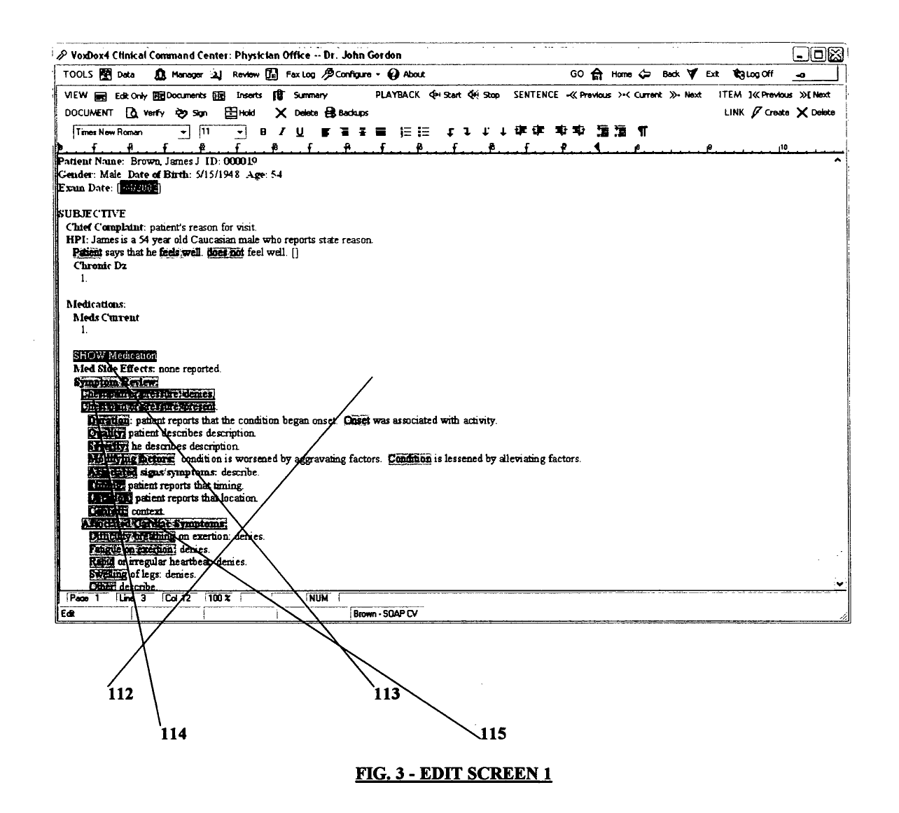

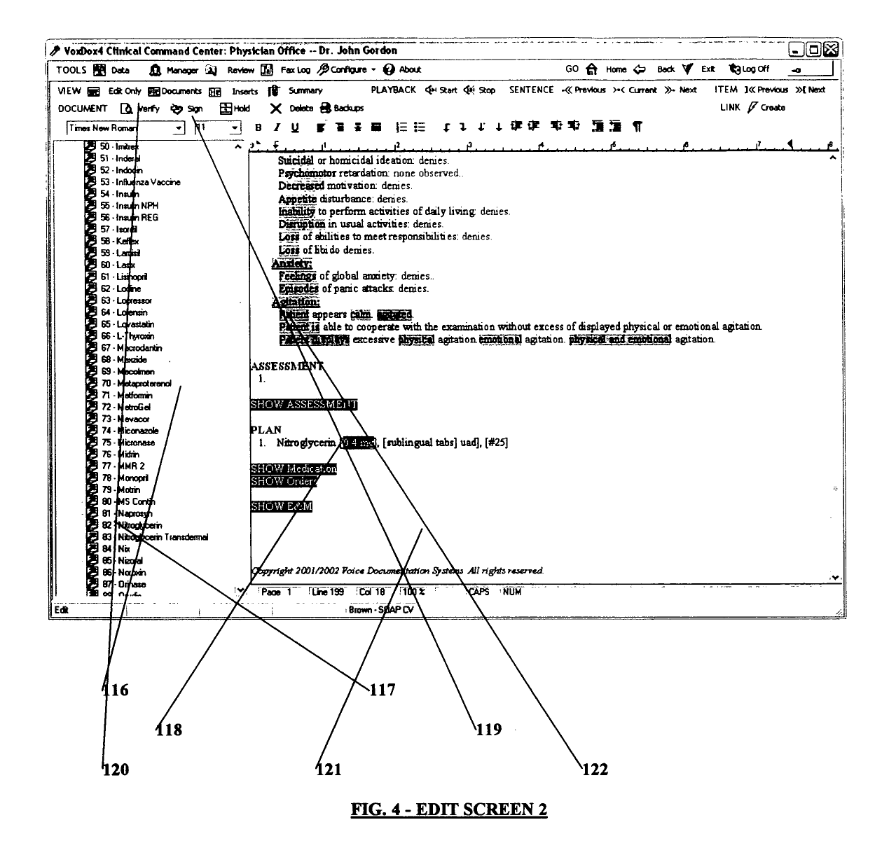

Editing—FIGS. 3, 4

When Edit button 109 is clicked, an Edit screen is activated on the computer monitor shown in FIG. 3. The template previously activated on the Home Screen is displayed in a main Edit Control 112, and the template becomes an editable document. The document can be navigated, (navigation is moving the insertion point or scrolling the document on the computer screen) by standard mouse and keyboard actions, as well as by voice commands.

The editable document can be made up of text and tags (marked text fields). Tags can be of different types, and depending upon their type, they can perform the following functions:
1) Automatically import data from a data source into the document.
2) Automatically import data from a data source into the document, and export any user-initiated changes in the imported data that are made in the document back to the data source such that the data in the data source is revised to reflect user-initiated changes.
3) Make sections of the document available to other documents.
4) Include sections of other documents into the current document.
5) Generate new documents.
6) Mark a section of the document being edited so that it is included or omitted in the final version of the document.
7) Specify formatting characteristics such as merging or not merging with a prior paragraph.
8) Replicate an entire document and make it available for editing.

The tags that perform function “6” above are called “Labels” in the program. The user may activate labels by implementing the standard mouse action of double-clicking on the label, as well as by speaking the voice command ‘Check <name>’, where <name> is the text visible in the label. An included Label 110 and the text following that label up to the next label or other ending tag, will appear in the final version of the document. An omitted label 109 and the text following that label up to the next label or other ending tag will not appear in the final version of the document. The program uses the convention that labels with a green background color will be included in the final document, and labels with a red background color will not be included in the final document.

A Label can also specify formatting information in the final document. Label 122 will merge the information controlled by the label with the previous paragraph as shown at 127 where the phrase, “Patient appears” is merged into the paragraph that begins, “Agitation.”

User activation of specific tags in the document can also navigate to specified information in the knowledge tree. For example, double-clicking a Show Medication tag 113 in the document will open a knowledge tree to the medication list in knowledge tree 116 as shown in FIG. 4. Links in the knowledge tree are activated by standard mouse actions or keyboard actions on the link nodes, or by using voice commands. Each or any of these actions will insert the content represented by the links into the document at the insertion point. For example, activating “Show Medication” tag 113 will open the medication section of knowledge tree 116. Knowledge tree 116 can be navigated by standard mouse actions or keyboard actions and/or by using voice commands on the folder nodes or on the links. A medication in knowledge tree 117 can be inserted into the document by standard mouse actions or keyboard actions and/or by using voice commands. The voice commands in this embodiment are “insert <name>” or “add <name>” where “name” is the generic name or trademark of the medication as shown in the knowledge tree. In this example the name is nitroglycerin.

It is useful to note that more information than the name of the medication, “nitroglycerin” was inserted into the document. In this case, information about dosage, means of administration of the medication, timing of the administration of the medication, and the number of units of the medication that the pharmacy is instructed to provide the patient are all included in the document, and therefore this information can be available to other documents such as the prescription that may be delivered to the pharmacy.

This is one example of using the knowledge tree to insert information into the document. Our system provides many such capabilities.

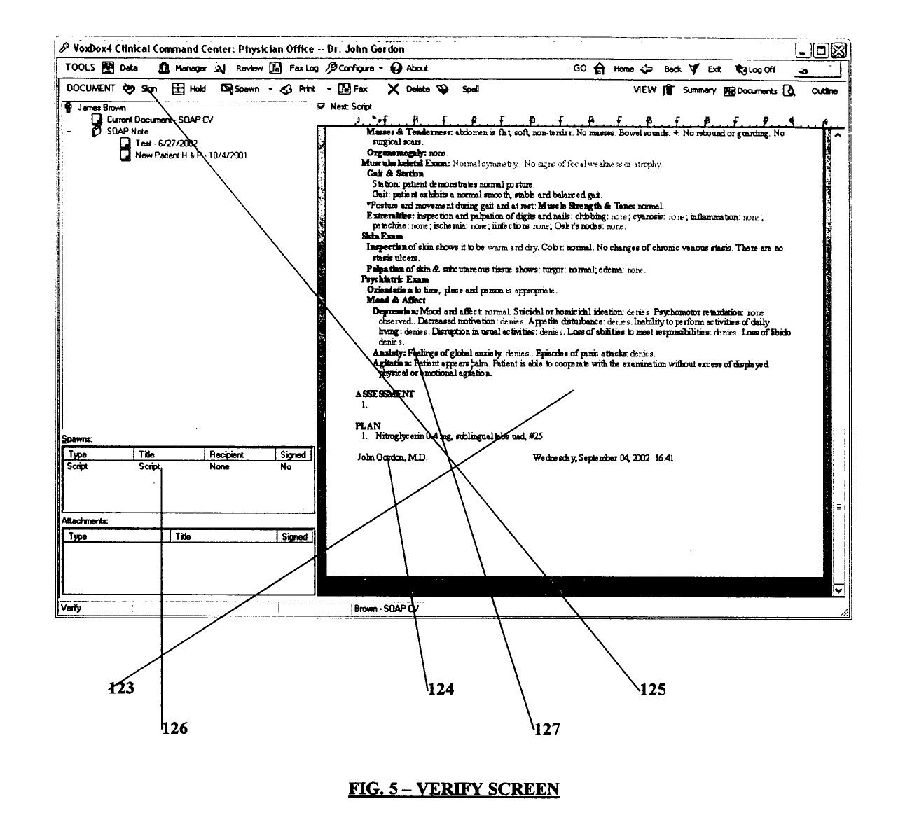

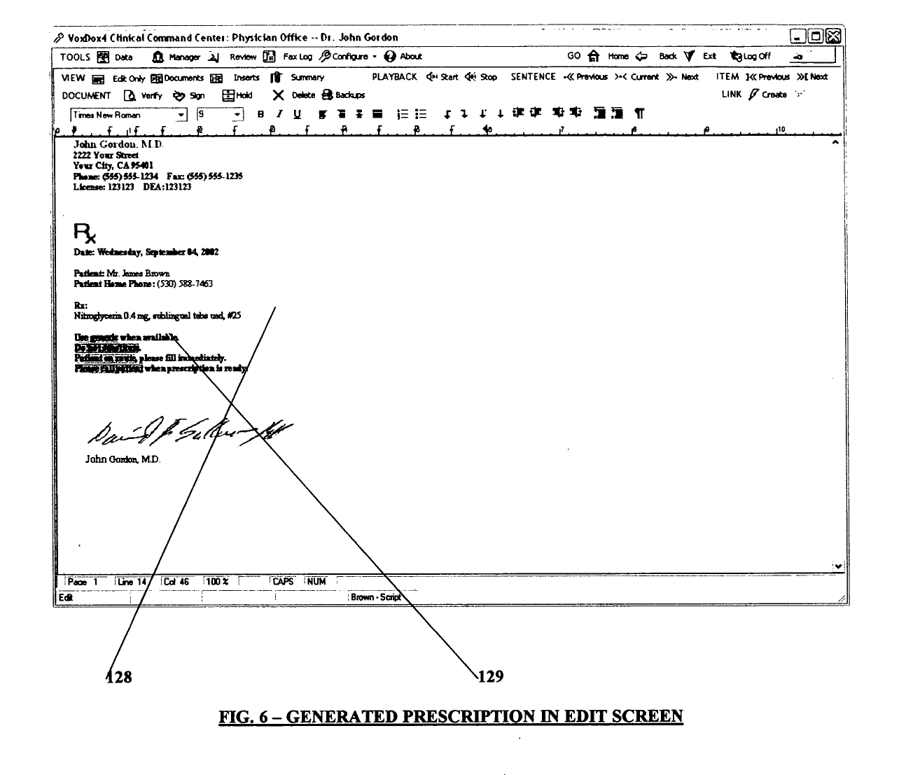

Finalizing the Document—FIGS. 5 and 6

When the document is determined to be complete by the user, clicking a a Verify Button 120 or a Sign Button 119 or will cause the omitted tags and text to be removed, and will automatically apply signature text. If a Verify Button 120 is clicked, the document is presented to the user in final form. The user may then review the document and, if necessary, return to the edit screen to make desired modifications before signing the document. If a Sign Button 119 is selected, the verify screen is skipped, and the document is completed and stored in its final form. The system does not allow signed documents to be modified.

If tags are present that generate other documents, these documents will be generated at this point. For example, if the user inserted one or more medications 117 from knowledge tree 116 into the document in the PLAN section, a prescription document will be generated. The generated prescription will include the medication(s) inserted into the PLAN. The generated document may contain all or part of the information presented in the source document. However, the ability to select certain information and omit other information is dependent upon the presence of discrete data elements (granules) in the source document.

If Verify Button 120 is selected, the Verify Screen will appear as shown in FIG. 5. The Verify Screen shows the document in its final form 123. Generated documents are listed under the heading Spawns 126. The term “spawn” is used since new documents are figuratively “spawned” from prior documents. When Sign Button 125 is activated, the document is stored in its final form in a database of documents. If generated documents are listed under the heading Spawns 126, they are then displayed in the Edit Screen of FIG. 6. Tags from a prior document can be automatically brought forward into a generated document 127.

After signing by selecting Sign Button 119, Home screen 1 as shown in FIG. 1 is once again displayed and the user may create and edit another document beginning the cycle all over again.

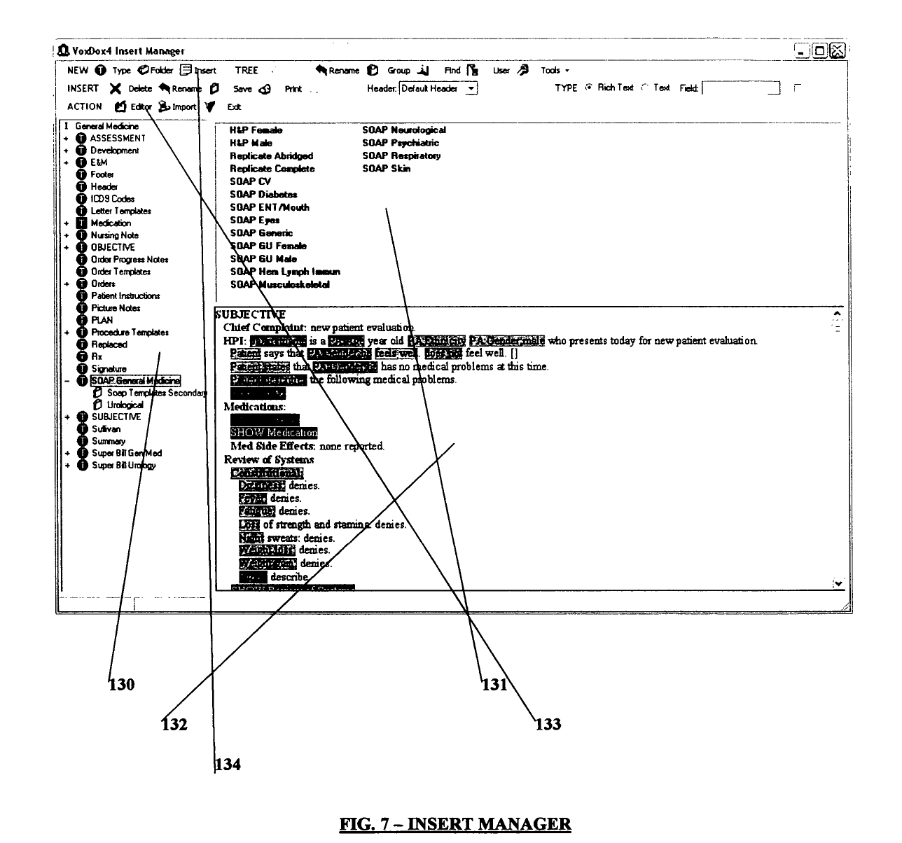

Creating and Editing Templates—FIGS. 1, 7,8

In our preferred embodiment, the software program provides an extensive set of templates and many elements of the knowledge tree. These templates cover a wide range of medical documentation alternatives. In cases where the user needs to modify existing templates or items in the Knowledge Tree, or where the user needs to create new templates, or add items in the Knowledge Tree, the program provides a set of tools for accomplishing these tasks, including the creation of the tags that are used in the Document Editor.

To create or modify templates, the user clicks the Manager Button 103 on a main toolbar 102 in FIG. 1. This opens a new window on the computer monitor, the Insert Manager FIG. 7. The Insert Manager consists of a tree structure 128 in the left-hand pane that contains templates. The upper right-hand pane contains a list of the templates in the selected node of a tree structure 129. Clicking on a template in the upper right hand pane causes the template contents to be shown in a lower right hand pane 130.

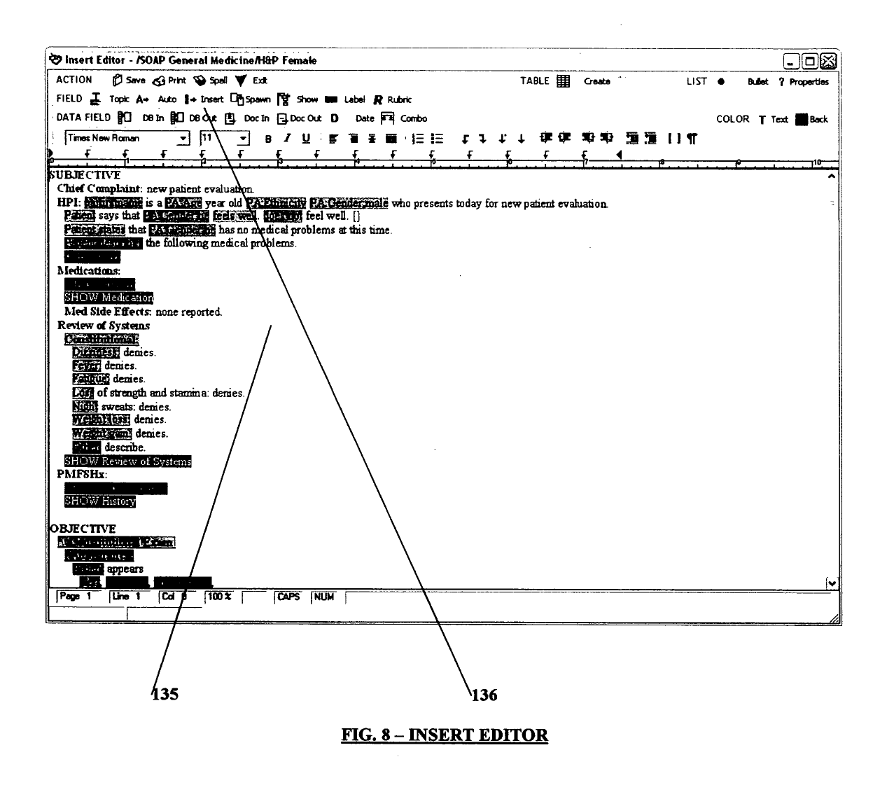

As shown in FIG. 8, a new template can be created by clicking the Insert Button on a NEW toolbar 132 and proceeding to give the new template a name.

If the user wishes to make only minor text modifications, these can be done directly in the lower right-hand pane. If the user wished to insert tags and to use more advanced text formatting, the work must be done in the Insert Editor. In order to activate the Insert Editor, the user clicks the Editor Button on a toolbar 131. This opens a new window on the computer monitor, the Insert Editor of FIG. 8. The Insert Editor contains Template Contents 133 selected in the Insert Manager, and provides a set of tools 134 to create the tags described above.

Creating and Modifying Document Types—FIGS. 1,9

In our preferred embodiment, the program creates documents of different types. A Document Type defines attributes of the individual documents that belong to it.

To create or modify a document type, the user clicks on the drop-down arrow of the Configure Button 107 on Main Toolbar 102 in FIG. 1, and then selects a menu item Document Type.

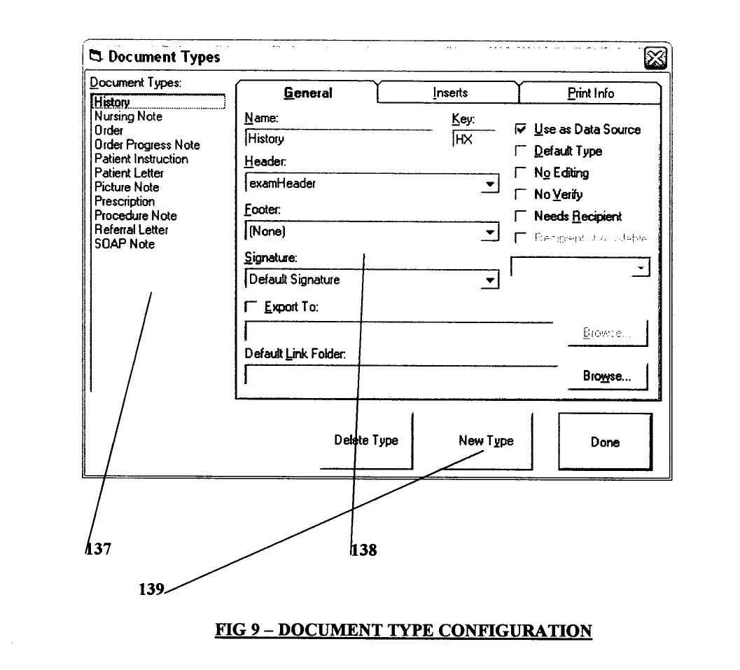

This opens a new window on the computer monitor, a Document Type screen, FIG. 9. To configure an existing Document Type, the user selects the type in the Document Type list 137. Then the Document Type characteristics 138 can be changed using mouse and/or keyboard input. Voice input could be used as well, but this feature is not presently provided in the program.

To create a new Document Type, the user clicks a New Type button 139 and then enters the name for the document type, followed by the characteristics the user chooses for this Document Type.

Business Method and Pricing Format

There is further disclosed a method of doing business utilizing document production. In one embodiment, the documentation process can be embedded into a business model that requires users to pay by the volume of documentation they produce (e.g. number of lines in a report or number of reports of certain types where the price is set by number of lines produced in a time period, e.g., a month or a week, or number of reports in a time period or both and where the price can differ by type of report). Alternatively users would pay by unit of time (e.g., month or year) or they can pay by both time and output or by the amount of time spent in a particular activity, e.g. creating reports, reviewing reports. These are alternatives to the usual model of buying a software license that give unlimited use.

Building the Program

The program in the attached CD (Appendix I) is called VoxDox4.2. VoxDox4.2 has been written in a high-level computer language (Visual Basic developed by Microsoft). It has been written using the IDE (Integrated Development Environment) supplied with Visual Basic. Our program makes use of standard Microsoft Windows supplied controls: Text Boxes, Labels, Command Buttons, TreeViews, ListViews, Pictures, Check Boxes, Radio Buttons, Combo Boxes, List Boxes, Timers, Tab Controls, Status Bars, Toolbars, Image Lists, Common Dialog Controls, and other similar controls. The program also uses controls from third-party suppliers. The third-party controls are: TXTextControl (the main edit control), WSSpell, a spell check control, FaxMan, a faxing control, and Dragon speech interface controls that allows communication between the program and a speech-recognition engine. The third-party controls are produced by several software houses and sometimes can be purchased directly from those houses or from software distributors. Appendix II contains a listing with contact information for the software houses.

The control used by the program to implement the knowledge tree is the TreeView control. The software program uses TXTextEditor control to implement the main edit control.

The TreeView control is a collection of nodes. Nodes can contain other nodes to implement the tree structure. The TreeView control nodes have been implemented as a set of links (pointers to information) and folders (containers of links to information and other folders). The sum of the links and folders in the TreeView control is called the Knowledge Tree. The Knowledge Tree is constructed using a set of tools provided by the program.

The main edit control contains the document being edited. One of its features is ability to define marked text fields. A marked text field is an area of the document that can contain user-defined, data that is not visible in the control. This allows the program to define tags that give structure to the document. In addition to giving structure to the document, the tags activate and control the Knowledge Tree. The tags also can perform these actions:
1) Automatically import data from a data source into the document.
2) Automatically import data from a data source into the document, and export any user-initiated changes in the imported data that are made in the document back to the data source such that the data in the data source is revised to reflect the user-initiated changes.
3) Make sections of the document available to other documents.
4) Include sections of other documents into the current document.
5) Generate new documents.
6) Mark a section of the document to be included or omitted from the final version of the document.
7) Specify formatting characteristics such as merging or not merging with a prior paragraph.
8) Replicate an entire document and make it available for editing.

Dragon Naturally Speaking version 5 is used to implement the speech functions described herein. Another speech engine could be used to obtain similar results.

In our preferred embodiment, the program runs under a Windows 95 or later operating system on a Pentium or AMD chip. However, as will be obvious to one skilled in the art, our documenting system can be practiced using other operating systems running on other chips.

In the above embodiment, VoxDox4.2 is our name for an application for the production of professional documents. Each application within VoxDox4.2 defines the constituent elements of the document types that it will produce. Each application starts with a set of document definitions, each defining the characteristics of the documents that belong to its type. VoxDox4.2 uses the document type to facilitate the document activities: creation, editing, signing (putting the document in its final form), and delivery.

VoxDox4.2 uses Extensible Markup Language (XML) as a standard to allow structure to be applied to these documents. Other markup languages can be used to achieve the same result. Speech technology is employed to allow users to put content in structured XML documents in a natural and intuitive way.

The use of XML opens vast possibilities in the areas of web publishing and distribution of information.

### Conclusion, Ramifications, and Scope

Thus it is seen that we have provided a method of documenting an activity with improved efficiency and completeness in recording information, with improved efficiency for retrieving information after it has been recorded, and with improved efficiency and accuracy for using already-recorded information in contexts other than the original context.

Our system presents solutions to the documentation challenges that are left unsolved by the present art by providing structure to the documentation process and structure to the documents themselves, thereby allowing more efficient production of documents and more efficient review of and extraction of information from completed documents.

Our system provides and maintains granularity in the information that is contained in the document. A user may select the information that is to be available in granular form. In any event, document structure and its cousin, granularity, when used with the Knowledge Tree are powerful features that give our system multiple advantages over the current state of the art.

In addition to medicine (clinical documentation) our system has other practical applications that can be grouped into several areas: Other Health Care (e.g. psychology, senior care, physical therapy), Law enforcement, Law, Social programs (governmental and non-governmental), Education, and General business. VoxDox4.2 utilizes the document as a prime data source. A structured document allows information to be used in context, while allowing precise extraction of the information when necessary. Moreover, the document, to some degree, defines the capabilities of the application, in that the document may specify where it should be stored, who may view it under various conditions, and how it may be created and edited.

Each of the application areas (Medicine, Law Enforcement, etc.) is made of specific sub-applications. In medicine, for example, sub-applications for the following specialties exist: Radiology, Podiatry, Plastic Surgery, Urology, Cardiology, Gastroenterology, Ear, Nose, and Throat, Dermatology, Respiratory Medicine, HIV Medicine, Neurology, Ophthalmology, Obstetrics, Gynecology, Pain Medicine, Orthopedics, Psychiatry, Internal Medicine, and General Medicine (Primary care). Sub-applications also exist for physical therapy.

In the above Detailed Description, for purposes of explanation, numerous specific details have been set forth in order to provide a thorough understanding of the invention. It will be apparent, however, to one skilled in the art that the invention can be practiced without these specific details. These specifics should not be construed as limiting the scope of the invention but as merely providing illustrations of some of the presently preferred embodiments of this invention. For example, the document can have structure other than the SOAP structure that is described. This is true when our documentation system is practiced within the field of medicine and when it is practiced in an entirely different field.

Thus the scope of the invention should be determined by the appended claims and their legal equivalents, rather than by the examples given.

1. A Method And Apparatus For A Document System, comprising:
(a) providing a knowledge tree onto which links to user-selected information can be placed,
(b) providing a structured document where structure is provided by tags that define starting and ending points in the document,
(c) linking said knowledge tree and said structured document such that the information to which there are links in said knowledge tree can be inserted at a chosen place in said structured document,
whereby a user can (1) select and insert information into the document as needed to quickly, completely and accurately create the document, (2) select information already in the document for inclusion or exclusion in the final document. (3) select information from a document and cause said information to be used in another document, and (4) define the level of granularity of the information that will be retained in the document according to perceived documentation needs.

2. The method of claim 1, further including providing means for inserting information linked in said knowledge tree by voice command.

3. The method of claim 1, further including providing means for inserting information linked in said knowledge tree by a mouse click or a series of mouse clicks.

4. The method of claim 1, further including providing means for inserting information linked in said knowledge tree by a keyboard stroke or a series of keyboard strokes.

5. The method of claim 1, further including providing means for inserting information linked in said knowledge tree by use of a touch screen.
